(19) United States
(12) Patent Application Publication
(10) Pub. No.: US 2002/0022505 A1
(43) Pub. Date: Feb. 21, 2002

(54) Circumferential thresher

(76) Inventor: James Henry Freeburn, Fontana, CA (US)

Correspondence Address: Patent Law & Venture Group, Suite K-105, 3151 Airway Ave., Costa Mesa, CA, 92626, US

(21) Appl. No.: 09/909,621

(22) Filed: Jul. 19, 2001

Related U.S. Application Data
(63) Continuation-in-part of application No. 09/639,374, filed on Aug. 15, 2000.

(51) Int. Cl. A23N 5/00

(52) U.S. Cl. 460/14

(57) ABSTRACT

A thresher provides a rotating roller and an arcuate fixed plate to thresh grain crops. The roller and the plate surfaces are constructed of a rubber-like material providing resiliency. The roller surface is provided with a series of crescent shaped paddles for catching and lifting the grain kernels. Grain kernels are stripped from a cut crop and moved past the stripping plate to a point on the roller for pickup and transport. In the preferred mode the fixed plate is positioned so that the gap between roller and plate narrows as the cut crop moves on the roller.

This application is a continuation in part application of a U.S. Ser. No. 09/639,374 filed on Aug. 15, 2000 and which contains subject identical to that described and claimed in the present application.

### BACKGROUND OF THE INVENTION

1. Field of the Invention

This invention relates generally to crop threshing machines, and more particularly to an improved thresher of simple construction and operation and having high efficiency in removing grain kernels from crop stalks.

2. Description of Related Art

Invention and use of crop threshing machines is known in the art. This art is represented by the following references:

van de Brand, U.S. Pat. No. 5,052,976, discloses an invention relating to a threshing device for pulse crops, the threshing device is provided with a roller shaped roller, rotatable about the horizontally arranged axis of rotation, the surface of the rolleer is provided with openings. In the interior of the roller there is arranged a main threshing means, which is rotatable about its axis of rotation extending at least substantially parallel to the axis of rotation of the roller, in such a manner that, during operation, parts of the main threshing means, located near the roller surface, move in the same direction as the adjacent part of the roller surface. The main threshing means is provided with projecting parts, which, besides imparting a component of movement to the crop, that is directed towards the interior surface of the roller, also imparts a component of movement to the crop in the longitudinal direction of the roller. The main threshing means is arranged near a part of the roller surface that moves upwards during operation, while a second auxiliary threshing means is provided, at a level intermediate the longitudinal axis of the first auxiliary threshing means and the longitudinal axis of the main threshing means, so that the second auxiliary threshing means is arranged near a part of the roller surface that moves downwards during operation.

Tognana, U.S. Pat. No. 5,026,322, discloses a device which has a first threshing rotor bearing a first number of radial blades, and a second counter-rotating loading rotor having a different number of radial blades. The rotors are arranged side by side and adapted to be driven in phase at different speeds. A fan generates a flow of air at a region of alignment of the radial blades of the first and second rotors, and the first rotor has a rear outlet for threshed leaves.

Mine, et al., U.S. Pat. No. 4,649,940, discloses a method and apparatus for threshing ribs from tobacco leaves and the like. The method comprises a basket having a grid in which a threshing gear formed with a rotary roller, including teeth on its periphery, is accommodated in such a manner that the outside portion of the gear is disposed spacedly adjacent to it, supplying raw material to the space between the threshing gear and the basket from one side of the axial direction, by an air flow at a predetermined speed corresponding to the peripheral speed of the gear, rotating the gear and raw material toward the crossing direction of the axis. The apparatus comprises a casing, a threshing gear formed with a rotary roller having teeth, a basket having a grid and surrounding the gear, the gear and basket being rotated at different peripheral speeds, a material supply port, a feed duct and a discharge opening.

Dammann, U.S. Pat. No. 4,606,355, discloses a harvester thresher which has an axial threshing and separating arrangement with two rotatable threshing rollers and two casing units surrounding the threshing rollers and having an upper product supply opening and a lower supply opening, a radial threshing mechanism located upstream of the axial threshing and separating arrangement as considered in a product flow direction, and a guiding element subdivided into an upper part which is bent upwardly to supply a product threshed by the radial threshing mechanism toward the upper product supply opening of the axial threshing and separating arrangement and a lower part which is bent downwardly to supply the product threshed by the radial threshing mechanism toward the lower product supply opening of the axial threshing an separating arrangement.

Muller, et al., U.S. Pat. No. 4,501,282, teaches a combined harvester having a crop elevator that feeds crop upwards across a crop floor to a crop threshing mechanism comprising a threshing cylinder located adjacent a concave threshing grate and driven to thresh crop fed tangentially between the cylinder and grat, a crop conveyor in the form of a roller or continuous band conveyor is located along the leading edge of the grate with respect to the crop feed direction so that crop passes over it to the cylinder and grate and a changeable speed drive mechanism is provided to drive the conveyor and allow its speed to be changed, so as to control the speed of crop flow. The crop elevator is supported to pivot about the axis of the cylinder to raise and lower a crop collecting table carried at the bottom of the elevator, the conveyor is located between the upper end of the elevator floor and the leading edge of the grate so as to form a substantially continuous crop flow path with the floor and grate. The grate and conveyor are mounted so as to pivot with the elevator about the axis of the cylinder. A crop guide flap is provided adjacent the conveyor to vary the angle at which the crop is fed to the cylinder.

Khan, U.S. Pat. No. 3,763,868, teaches a threshing machine of the rotary table-type which has a horizontally split housing defining an annular opening. Within the housing is a horizontally disposed, rotary threshing table with a plurality of outwardly inclined threshing blades secured on its upper surface, and several radial fan blades on the lower surface. Disposed concentrically with the rotary threshing table, adjacent to its periphery, is a rotary annular perforated surface which rotates at a slower rate than the rotary threshing table and over which the threshed materials pass as the latter are thrown off the rotary threshing table.

Above the rotary annular perforated surface, and adapted to cooperate with it, is an annular member, on the bottom side of which are several uniformly spaced apart spiral plates.

Andersen, U.S. Pat. No. 3,038,476, discloses a threshing mechanism comprised of a cylinder and associated concave surface forming a first threshing unit and a cylinder and associated concave surface forming a second threshing unit. The latter is located above the first unit with the cylinder axis lying in the same vertical plane as the concave surfaces and disposed at opposite sides of the plane. In operation, cut crop material is fed into the first threshing unit by the feeding mechanism. As the material enters the first unit, the grain is knocked by the cylinder through the concave surface onto a grain collector. Straw and any grain remaining is passed by the cylinder, up through the passage, to the second threshing unit. The grain separated there drops into a grain collector from which an auger at its lower end carries the separated grain to mix with the grain on the collector for delivery to the usual cleaning mechanism. The straw from the second unit is discharged through a chute to the usual straw walkers.

However, the prior art does not teach a thresher that moves cut crops in a circumferential direction with no axial movement. The present invention fulfills these needs and provides further related advantages as described in the following summary.

### SUMMARY OF THE INVENTION

The present invention teaches certain benefits in construction and use which give rise to the following objectives. The principles of threshing have been applied using machines that beat, and/or pull crops apart. As seen in the background above, the application of moving surfaces is well applied. The present invention also uses the basic principle of relative surface motion to separate the grain kernels from the stalk and other chaff that forms the basis of cut crop portions.

The present invention uses a revolving roller in close contact with a stationary curved plate. Crop cuts are fed to the roller and are then carried between the roller and the curved plate. The space between the roller and the plate is set so that the crop is threshed, the grain kernels being pulled from the stalk. The kernels, stalk and chaff are then caught and pushed by crescent shaped protrusions on the roller to a moving air or other type of transport device where the kernels are separated out.

Thus it is an object of the present invention to provide an improved thresher for cut grain crops. It is a more explicit object to provide such a thresher having differential motion between a roller and a fixed arcuate shaped plate. It is a further object of the present invention to provide a thresher of the sort described herein which moves grain and other cut crops in a circumferential direction only around a roller while drawing such crops into a diminishing throat having threashing surfaces.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention, an apparatus for thrashing a grain crop. In such drawings:

FIG. 1 is a schematic diagram of a side elevational view of the invention particularly showing the relationship between a threshing roller and a fixed arcuate plate;

FIG. 2 is a partial elevational view of a comb; part of a blade from a prior art crop stripping device used in conjunction with the present thresher;

FIG. 3 is a partial perspective view of the underside surface of the fixed arcuate plate of the present invention; and

FIG. 4 is a partial perspective view of the outer surface of the roller of the present invention.

### DETAILED DESCRIPTION OF THE PREFERRED EMBODIMENT

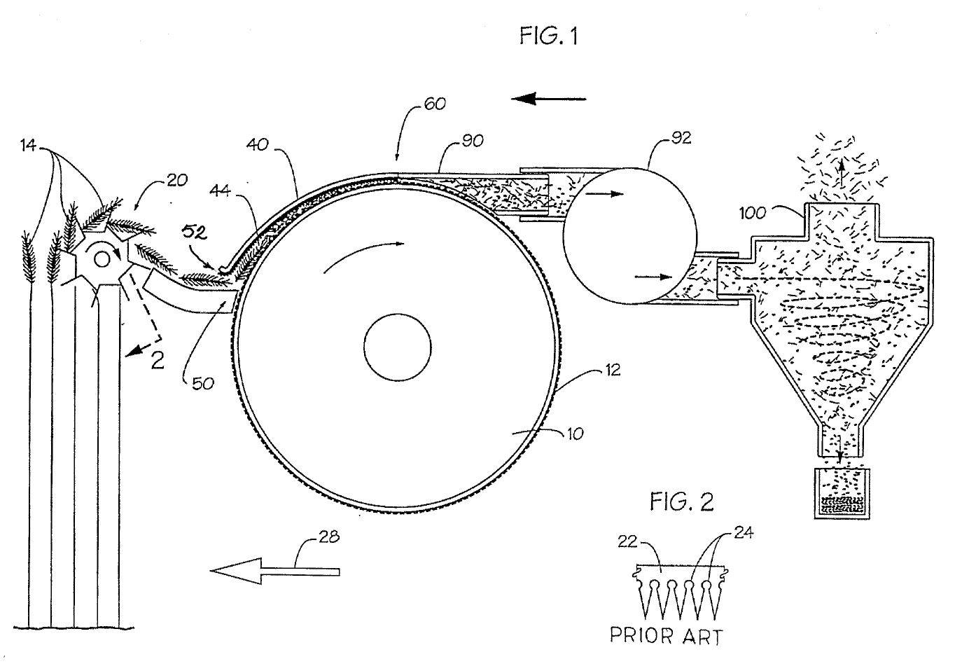

The above described drawing FIGS. 1-4, illustrate an apparatus and method for threshing cut crop portions 14, that is, those portions of field crops that are cut or stripped away for threshing. Now, as seen in FIG. 1, a continuously rotating threshing roller 10 provides an outwardly directed rubber-like surface 12 having extending outwardly from it, a plurality of crescent shaped protrusions 30 (see FIG. 4) arranged in overlapping positions on the surface 12 of the roller 10. An arcuate plate 40 is positioned generally above the roller 10 and in near contact with it. A rubber-like surface 42 of the plate 40 has a complimentary shape to the general contour of the roller 10 and is positioned so as to face the roller 10 as shown in FIG. 1.

The cut crop portions 14 comprising primarily crop stalk pieces 15 with grain kernels 16 attached, are fed into a throat 50 formed by the surface 12 of the roller 10 and the plate 40, the roller 10 drawing the portions 14 into the throat 50. The portions 14 are threshed between the surface of the roller 10 and the surface of the plate 40 so that kernels 16 separated from the portions 14 are carried by the roller 10 to a position 60 for pickup and transport.

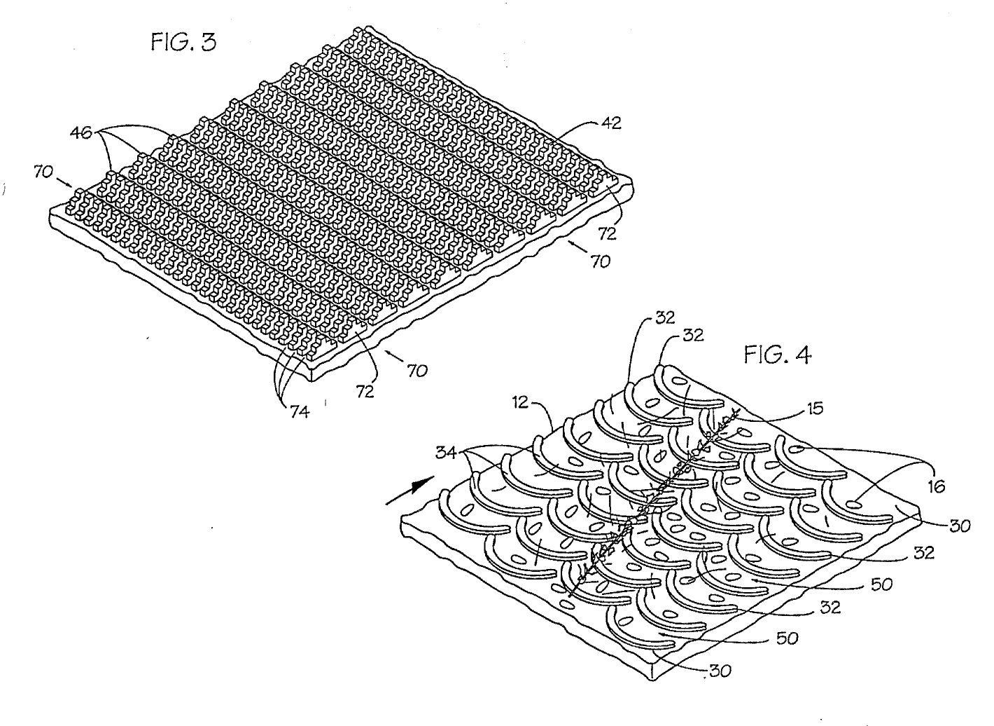

Preferably, the plate 40 is positioned to form an open gap 44 between the surfaces 34 of the crescent shaped protrusions 30 and the tips 46 of the undulations 70 of the fixed plate surface 42, the gap diminishing in size in the direction of grain motion on the rotating roller 10. In this manner, the cut portions 14 are compressed and threshed with ever more vigor as they move with the roller 10 against the surfaces of both the roller 10 and the plate 42. The inventive steps involved in this invention include the use of rubber-like surfaces, which because of their resiliency improves the threshing action over that of the machines described and taught in the prior art. The further inventive step of providing crescent shaped protrusions 30 on the surface 12 of the roller 10 enables the capture and lifting of grains 16 pulled from the cut crop portions 14. The surface 42 of the plate 40 may have any roughened texture but it has been found to be advantageous to provide a surface contour as shown in FIG. 3, having a series of transverse wave-like undulations 70, and preferably the undulations 70 are each separated into a series of fingers 72 with spaces 74 between them (FIG. 3). It has been discovered that such a fixed plate surface 42 as herein described provides a significant improvement in the threshing of grain crops over the prior art.

Specifically, the present method for threshing grain crops comprises the steps of, first cutting a grain crop at the stalk to provide cut crop portions 14 which normally includes mature grain kernels 16 for harvesting. In the preferred method of the invention, this is accomplished by any of the well known techniques in the prior art, but most preferably by the use of a header 20, such as the commercial machines of the Shelbourne Reynolds company of Suffolk, England. Such a Header uses combs 22 as shown in FIG. 2. Such combs provide openings 24 as seen in FIG. 2, so that the upwardly rising combs strip the grain heads from the lower stalks as shown in schematic representation in FIG. 1 which represents the possibility of the thresher being mounted for moving in the field in the direction shown by arrow 28. In this approach the fruit of the crop is lifted from the ends of the stalk and brought into the thresher continuously, without a significant amount of the stalk being involved. The cut crop portions 14 are moved to an inlet throat 50 formed by the surface 12 of the revolving roller 10, and the fixed arcuate plate 40 which is adjacent to the roller. The surface 12 has crescent shaped protrusions 30 extending from it. Next, the roller 10, which is constantly rotating, forces the cut crop portions 14 between the roller surface 12 and the arcuate plate surface 42 which results in the break-out of the kernels 16 from the cut crop portions 14. Rotating further, the roller 10 moves the kernels 16 away from the arcuate plate 40 to a point 60 for pickup and transport of the kernels. The kernels 16 are preferably transported by a moving air system 90 such as shown in FIG. 1. Such a system may employ an auger to move the kernels 16 to a common point of pickup, or may use a manifold suction device to lift and transport kernels 16 directly from the roller 10, through an air moving device 92, to a separator 100, such as a cyclone type system for separating the kernels from the stripped stalk 15, and the chaff.

The present invention may more particularly be described as to its most important elements, as including a continuously rotating threshing roller 10 providing an outwardly directed surface 12 including a plurality of protrusions 30 on the outwardly directed surface 12. The protrusions 12 are adapted by shape for engaging the cut crop portions 14 which are directed against one side of the threshing roller 10, and for lifting the cut crop portions 14 toward a top, shown generally by reference numeral 60, of the threshing roller 10 as the threshing roller rotates. Please see the direction of rotation shown by an arrow in FIG. 1. An arcuate plate 40 extends from the one side of the threshing roller (the left side in FIG. 1) to the top 60 of the threshing roller 10, thereby forming a crop portions receiving throat 50 between the arcuate plate 40 and the outwardly directed surface 12 of the threshing roller 10. A receiving throat entrance aperture 52 is axially aligned with the threshing roller 10 at the one side, i.e., along the one side. The arcuate plate 40 is positioned so that the receiving throat 50 diminishes in size in the direction of rotation of the threshing roller 10 but is constant in size axially.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An apparatus for threshing cut crop portions comprising: a continuously rotating threshing roller providing an outwardly directed surface including a plurality of protrusions on the outwardly directed surface, the protrusions adapted by shape for engaging cut crop portions directed against one side of the threshing roller, and for lifting the cut crop portions toward a top of the threshing roller as the threshing roller rotates; an arcuate plate extending from the one side of the threshing roller to the top of the threshing roller, thereby forming a crop portions receiving throat between the arcuate plate and the outwardly directed surface of the threshing roller, a receiving throat entrance aperture axially aligned with the threshing roller at the one side thereof, the arcuate plate positioned so that the receiving throat diminishes in size in the direction of rotation of the threshing roller, the throat being constant in size axially.

2. The apparatus of claim 1 wherein the arcuate plate provides a surface texture of transverse undulations.

3. The apparatus of claim 2 wherein the transverse undulations provide spaced apart fingers.

4. The apparatus of claim 1 wherein the outwardly directed surface is of a rubber material.

5. The apparatus of claim 1 wherein the outwardly directed protrusions are crescent shaped and positionally oriented in the direction or rotation of the threshing roller.
